(19) United States
(12) Patent Application Publication
(10) Pub. No.: US 2025/0119891 A1
(43) Pub. Date: Apr. 10, 2025

(54) POSITION DIFFERENCE BASED TIME-FREQUENCY PATTERNS FOR WIRELESS SENSING SIGNALS

(71) Applicant: ZTE Corporation, Shenzhen (CN)

(72) Inventors: Yihua MA, Shenzhen (CN); Zhifeng YUAN, Shenzhen (CN); Shuqiang XIA, Shenzhen (CN); Guanghui YU, Shenzhen (CN); Liujun HU, Shenzhen (CN); Chuangxin JIANG, Shenzhen (CN); Zhiqiang HAN, Shenzhen (CN)

(21) Appl. No.: 18/983,999

(22) Filed: Dec. 17, 2024

Related U.S. Application Data
(63) Continuation of application No. PCT/CN2022/141507, filed on Dec. 23, 2022.

(51) Int. Cl. H04W 72/0453; H04W 72/0446; H04W 72/20

(52) U.S. Cl. CPC H04W 72/0453; H04W 72/0446; H04W 72/20

(57) ABSTRACT

This patent application discloses methods, apparatus, and systems that relate to position difference-based time-frequency resource patterns for wireless sensing signals. In one example aspect, a method for wireless communication includes transmitting, by a first wireless device, a signal at N resource positions, where N is a positive integer, wherein a set of position differences generated on the N resource positions includes at least a predetermined percentage of a set {0, d, 2d, . . . , (L−1)d}, wherein L is an integer larger than N, wherein d is a unit time- or frequency-domain position differences.

### CROSS REFERENCE TO RELATED APPLICATIONS

This patent document is a continuation of and claims benefit of priority to International Patent Application No. PCT/CN2022/141507, filed on Dec. 23, 2022. The entire content of the before-mentioned patent application is incorporated by reference as part of the disclosure of this application.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

### SUMMARY

This patent document discloses techniques, among other things, related to generation, configuration and communication of position-difference based time-frequency patterns for wireless sensing signals.

In one example aspect, wireless communication method is disclosed. The method includes transmitting, by a first wireless device, a signal at N resource positions, where N is a positive integer, wherein a set of position differences generated on the N resource positions includes at least a predetermined percentage of a set {0, d, 2d, . . . , (L−1)d}, wherein Lis an integer larger than N, wherein d is a unit time-or frequency-domain position differences.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

These, and other, aspects are further described throughout the present document.

### BRIEF DESCRIPTION OF THE DRAWING

FIGS. 1-3 show diagrams of examples involving generating and communicating position difference-based non-uniform sensing resource configuration signals in wireless communication systems.

FIGS. 4-9 show diagrams of examples involving position difference-based non-uniform sensing resource configuration

FIGS. 10-11 show diagrams of examples of position difference based non-uniform resource patterns.

FIG. 12 shows an exemplary block diagram of a hardware platform that may be a part of a network device or a communication device.

FIG. 13 shows an example of network communication including a base station (BS) and user equipment (UE) based on some implementations of the disclosed technology.

FIGS. 14-15 are flowcharts representation of methods for wireless communication in accordance with one or more embodiments of the present technology.

### DETAILED DESCRIPTION

Headings for the various sections below are used to facilitate the understanding of the disclosed subject matter and do not limit the scope of the claimed subject matter in any way. Accordingly, one or more features of one section can be combined with one or more features of another section. Furthermore, 6G or Integrated Sensing and Communication (ISAC) terminology is used for the sake of clarity of explanation, but the techniques disclosed in the present document are not limited to 6G or ISAC technology only and may be used in wireless systems that implement other protocols.

ISAC is expected to create considerable add-on values to the wireless communication system. The widely deployed communication infrastructures can be enhanced to provide radar services like traffic control and surveillance, drone detection, and railway obstacle detection. ISAC can also be realized by the various mobile communication devices in the scenarios of autonomous driving, smart homes, and health care.

Communication and radar utilize electromagnetic waves in two different ways. The idea of dual-function design can be traced back to the 1960s. It has attracted more and more research attention in recent years. There are many driving factors, including (1) the spectrum has been well exploited for two separate systems, and the joint spectrum utilization is expected to improve the efficiency and flexibility; (2) the hardware designs both have a technology trend of multiple antennas and digital baseband, and the share of hardware saves the cost; (3) the information fusion and mutual reinforcement of two functions brings performance gain, especially for autonomous vehicles.

Sensing in ISAC or other communication systems should aim to avoid a large resource overhead. One way is to design a non-uniform pattern. The non-uniform resource pattern is usually randomly generated, which satisfies the sampling requirements of the compressed sensing, and this randomly generated pattern has different performances. One common way is to optimize the shape of the main lobe and the sidelobe in the correlation pattern. However, this method only ensures the performance of the first-order correlation. This patent aims to ensure the integrity and continuity of the second-order covariance matrix. Note that this basic idea has been applied in the antenna array design, like minimum redundancy line array and nested array, to reduce the number of antenna elements. However, it has not been used by the time-frequency signal design.

One major challenge of ISAC is allocating a limited spectrum of resources to ensure the performance of both sensing and communication functions. One possible way to save the resource overheads is to allocate the sensing function with non-uniform and/or a-periodic, time-frequency resources. This patent application discloses multiple methods and apparatus schemes for the design of non-uniform resource patterns.

The proposed methods and schemes in the current application are beneficial in increasing the flexibility and efficiency of communication resource utilization in ISAC or other communication systems.

The details of the proposed methods will be discussed in the following embodiments.

### Embodiment 1

This section discloses, among other things, examples of configuring and transmitting sensing resource patterns.

Here the resource can be in either the time domain or frequency domain.

The sensing resource patterns can be configured from a higher layer, e.g., a CN.

The sensing resource pattern can be represented in different manners.

In one example, a sensing resource pattern can generate and transmitted as a list of elements, where each element is the multiplication of a position of time/frequency resources and a unit position different d. For example, a CN directly transmits the positions of [0 1 2 5 10 15 26 37 48 59 65 71 77 78 79]*d, where d is the unit position difference, which can be a positive integer configured within the communication system.

In another example, a sensing resource pattern can be generated and transmitted by a list containing elements representing positions of time/frequency resources and a unit position difference d. In other words, the transmitting node may transmit the resources' positions and the unit position difference d separately. And the receiving node may generate the resource patterns based on both parameters.

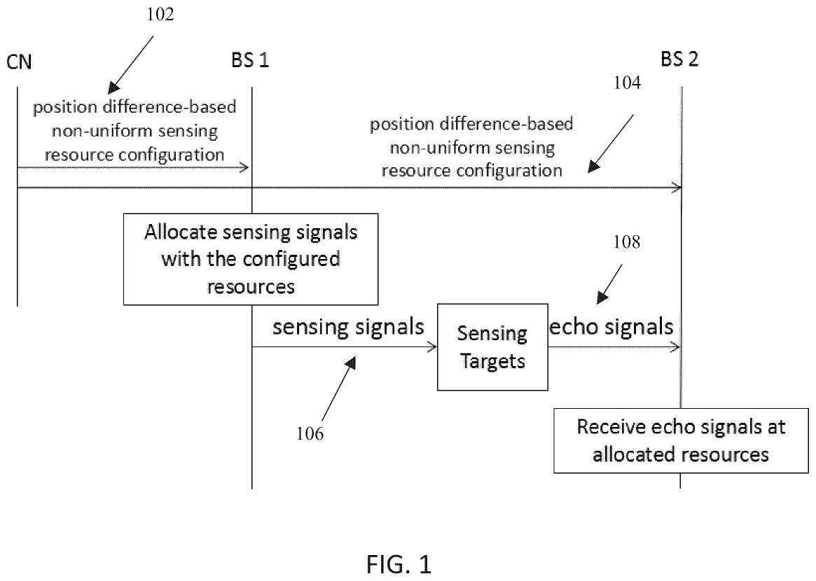

FIG. 1 discloses an example with a resource pattern of [0 1 2 5 10 15 26 37 48 59 65 71 77 78 79] and unit position difference d=seven symbols in the time domain.

According to FIG. 1, a CN sends a signal comprising configuration information related to position difference-based sensing resources to BS to BS 1 (102) and BS 2 (104).

The configuration information may also contain other parameters for the receiver to determine the position of the resource pattern. For example, the configuration information may contain resource allocation information of SFN0 Offset, slot offset, symbol offset, comb size, resource bandwidth, and a start physical resource block (PRB). As the resource pattern is in the time-domain, the SFN0 Offset, slot offset, and symbol offset decide the starting time-domain position of this resource pattern, and the comb size, resource bandwidth, and start PRB decide the frequency-domain resource allocation.

In the example shown in FIG. 1, the CN can either send one lists [0 1 2 5 10 15 26 37 48 59 65 71 77 78 79]×7 or send both list [0 1 2 5 10 15 26 37 48 59 65 71 77 78 79] and the position difference d, i.e., 7, separately.

After receiving the configuration, BS 1 may allocate the sensing signals according to the resource pattern generated based on the list [0 1 2 5 10 15 26 37 48 59 65 71 77 78 79]×7 slots and resource allocation information. BS1 may then transmit the sensing signal on the determined allocated resources.

According to FIG. 1, the sensing signals arrive at the sensing targets (106) that further generate corresponding echo signals to propagate to the receive antennas of BS 2 (108).

Since BS2 already receives the configuration information from the CN, BS2 may receive the echo signal according to that resource configuration.

### Embodiment 2

This section discloses, among other things, examples of configuring and transmitting sensing resource patterns.

Here the resource can be in either the time domain or frequency domain.

The sensing resource patterns can be configured from a higher layer, e.g., a CN.

The sensing resource pattern can be represented in different manners.

In one example, a sensing resource pattern can be generated and transmitted as a pattern index and a unit position different d. The pattern index is the index of a unit resource pattern in a common pattern list. For example, a CN directly transmits a pattern index=6 in the common pattern list, which is the following table, a unit position different d=4 slots.

In another example, a sensing resource pattern can be generated through positions shifting a resource pattern in a table. For example, as showed in Table 1. Here, Nis an integer representing the number of elements in the list. L is an integer representing the element number of {0, d, 2d, . . . , (L−1)*d}.

TABLE 1

| N | L | Resource Pattern |
|---|---|---|
| 3 | 4 | [0 1 3]*d; |
| 4 | 7 | [0 1 4 6]*d; |
| 5 | 10 | [0 1 2 6 9]*d; |
| | | [0 1 4 7 9]*d; |
| 6 | 14 | [0 1 2 6 10 13]*d; |
| | | [0 1 4 5 11 13]*d; |
| | | [0 1 6 9 11 13]*d; |
| 7 | 18 | [0 1 2 3 8 13 17]*d; |
| | | [0 1 2 6 10 14 17]*d; |
| | | [0 1 2 8 12 14 17]*d; |
| | | [0 1 2 8 12 15 17]*d; |
| | | [0 1 4 10 12 15 17]*d; |
| | | [0 1 8 11 13 15 17]*d; |
| 8 | 24 | [0 1 2 11 15 18 21 23]*d; |
| | | [0 1 4 10 16 18 21 23]*d; |
| 9 | 30 | [0 1 2 14 18 21 24 27 29]*d; |
| | | [0 1 4 10 16 22 24 27 29]*d; |
| | | [0 1 3 6 13 20 24 28 29]*d; |
| 10 | 37 | [0 1 3 6 13 20 27 31 35 36]*d; |
| 17 | 102 | [0 1 2 5 10 15 26 37 48 59 70 81 87 |
| | | 93 99 100 101]*d; |
| 18 | 113 | [0 1 2 5 10 15 26 37 48 59 70 81 92 |
| | | 98 104 110 111 112]*d; |

Apart from the sensing resource pattern, the configuration information also contains resource allocation of SFN0, slot offset, symbol offset, bandwidth, comb size, starting PRB, and sequence ID. The transmitter and receiver use the index of 6 to find the corresponding pattern [0 1 4 5 11 13]*d and decide the time-domain sensing resource pattern. The transmitter and receiver use the SFN0, slot offset, symbol offset to decide the time starting positions of the sensing resource pattern. The transmitter and receiver use the comb size, bandwidth and starting PRB, to decide the frequency positions of the sensing resource pattern. The transmitter and receiver use the sequence ID to determine the sequence to generate the signal in one time position.

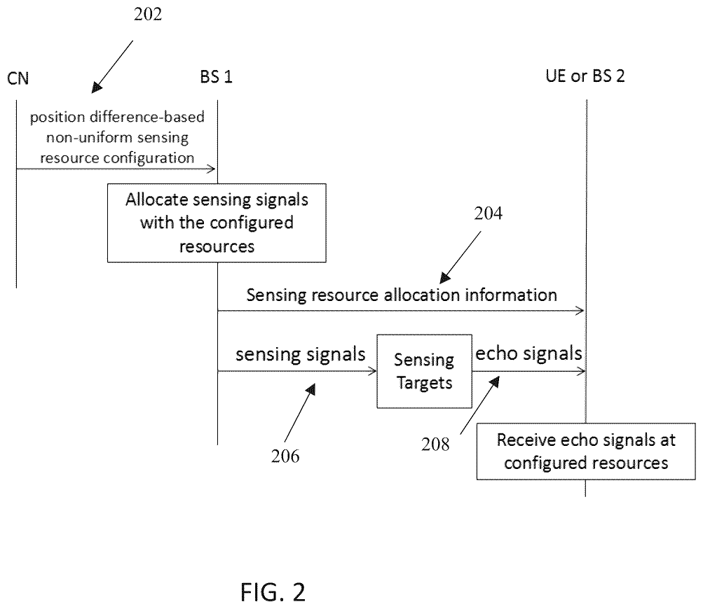

FIG. 2 discloses an example with a resource pattern of [0 1 2 5 10 15 26 37 48 59 65 71 77 78 79] and unit position difference d=4 slots in the time domain.

According to FIG. 2, a CN sends a signal comprising configuration information related to position difference-based sensing resources to BS1 (202).

In the example shown in FIG. 2, the CN can send the configuration containing the index and the position difference d.

After receiving the configuration, BS 1 may allocate the sensing signals according to the resource pattern generated based on the index, d, and other settings.

BS1 may transmit the sensing resource allocation information further to another wireless node, e.g., a UE or a BS2 (204).

According to FIG. 2, BS1 may transmit the sensing signal on the determined allocated resources. The sensing signals arrive at the sensing targets (206) that further generate corresponding echo signals to propagate to the receive antennas of UE or BS 2 (208).

Since UE or BS2 already receives the configuration information from BS1, it may receive the echo signal according to that resource configuration.

### Embodiment 3

This section discloses, among other things, examples of configuring and transmitting sensing resource patterns.

Here the resource can be in either the time domain or frequency domain.

The sensing resource patterns can be configured from a higher layer, e.g., a CN.

The sensing resource pattern can be represented in different manners.

In one example, a resource pattern can be generated based on pattern parameters. For example, a network node can transmit pattern parameters and unit position difference d to another network node to generate a resource pattern.

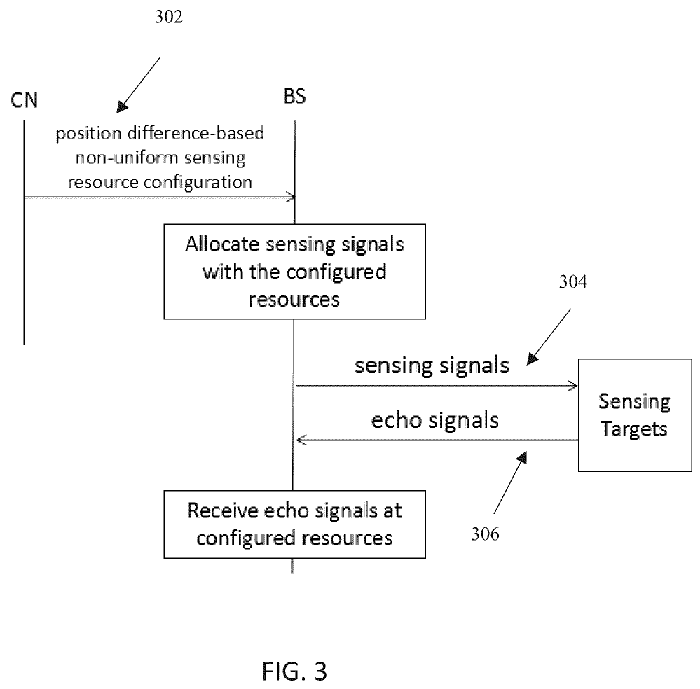

In one example, as shown in FIG. 3, a CN transmits pattern parameters N₁=23 and N₂=33, and a unit position difference d to a BS. Here, the position difference-based pattern is in the frequency domain and sub-carrier-wise, and d=1 sub-carrier.

According to FIG. 3, a CN sends a signal comprising configuration information to BS (302), including N₁, N₂, d, starting frequency positions and slots, SFN0, slot offset, symbol offset, and sequence ID. The transmitter and receiver use the frequency-domain sensing resource positions' N₁, N₂, d, and starting frequency positions. The transmitter and receiver use the SFN0, slot offset, and symbol offset to decide the time positions of the sensing resource pattern. The transmitter and receiver use the sequence ID to determine the sequence to generate the signal in a one-time position.

The configuration information may also contain other parameters for the receiver to decide the frequency-domain starting position and frequency-domain resource allocation of the resource pattern. For example, the configuration information may contain at least one of periodicity and resource set slot offset, resource repetition factor, resource time gap, muting options, SFN0 Offset, resource list, comb size, resource bandwidth, or start PRB, number of symbols within a slot. The resource list further includes resources configurations, which may contain resource ID, sequence ID, comb size and resource element offset, resource slot offset, resource symbol offset, and Quasi Co-Location (QCL) information.

BS receives the configuration information and generates the position difference-based resource pattern according to a certain rule. In one example, BS may generate the position difference-based resource pattern at {1, 2, 3, . . . , N₁}∪{(N₁+1), 2(N₁+1), 3(N₁+1), . . . , N₂(N₁+1)} sub-carriers.

BS transmits the sensing resource allocation information to UE or BS2. BS transmits the sensing signals. The sensing signals arrive at the sensing targets, and the corresponding echo signals propagate to the receiving antennas of BS1. BS1 receives the echo signals.

After generating the resource patterns, BS may allocate the sensing signals based on the resource pattern and send out the sensing signals accordingly.

According to FIG. 3, BS may transmit the sensing signal on the determined allocated resources. The sensing signals arrive at the sensing targets (304) that further generate corresponding echo signals to propagate to the BS (306).

Since BS already knows the configuration information, it may receive the echo signal according to that resource configuration.

### Embodiment 4

This embodiment discloses, among other things, an example of a time-domain position-difference-based resource pattern.

The resource pattern is [0 1 2 6 9]d, the unit position difference d=1 sub-frames.

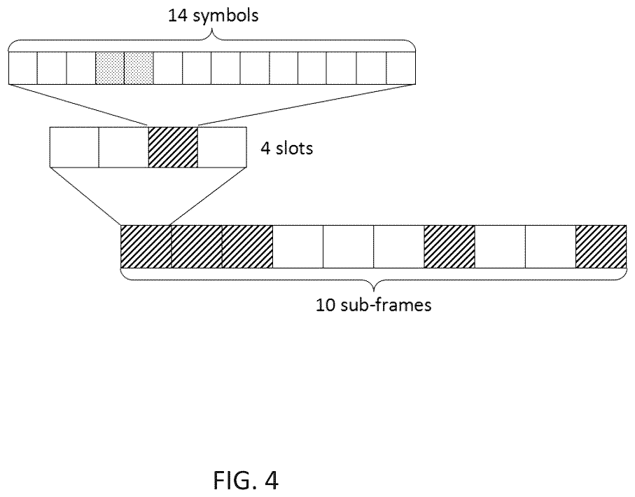

As shown in FIG. 4, this resource pattern can be combined with resource allocation parameters in the configuration information to decide the resource positions. In this figure, the resource allocation parameters include SFN0=0, the slot offset is 2, and the symbol offsets are 3 and 4. The sensing signal may configure to use symbols 3 and 4 in slot 2 in the sub-frame 0, 1, 2, 6 and 9. The frequency resource allocation can be decided by other frequency-domain parameters, including comb size, resource bandwidth, and start PRB.

The proposed method in this embodiment is not limited to the time domain. In other words, this method may also apply to generate resource patterns in the frequency domain or other resource domains.

### Embodiment 5

This embodiment discloses, among other things, an example of a frequency-domain position-difference-based resource pattern.

This embodiment shows a frequency-domain position-difference-based resource pattern. The resource pattern is [0 1 2 11 15 18 21 23]*d, the unit position difference d=1 RB. Apart from the resource pattern, the configuration information also includes the resource allocation of starting PRB=2, which means the starting position of this resource pattern is PRB 2. The time-domain resource allocation can be decided by other related parameters, including SFN0, slot offset, symbol offset and periodicity and repetition factor/number.

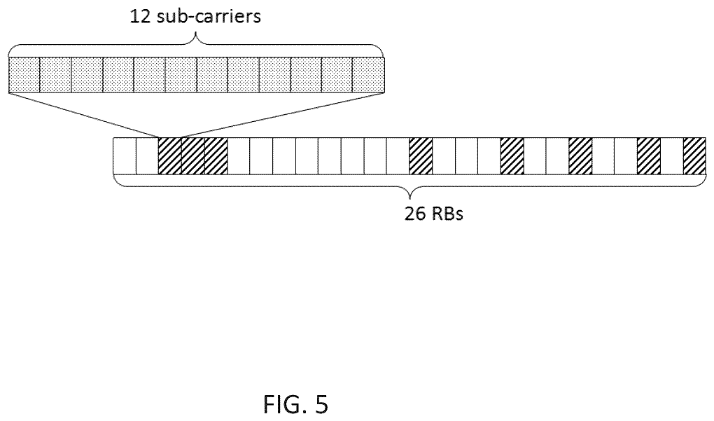

As shown in FIG. 5, the sensing signal may configure to use all 12 sub-carriers of each RB in the frequency-domain resource pattern starting from PRB 2.

The proposed method in this embodiment is not limited to the frequency domain. In other words, this method may also apply to generate resource patterns in the time domain or other resource domains.

### Embodiment 6

This embodiment discloses, among other things, an example of a time-domain position-difference-based resource pattern.

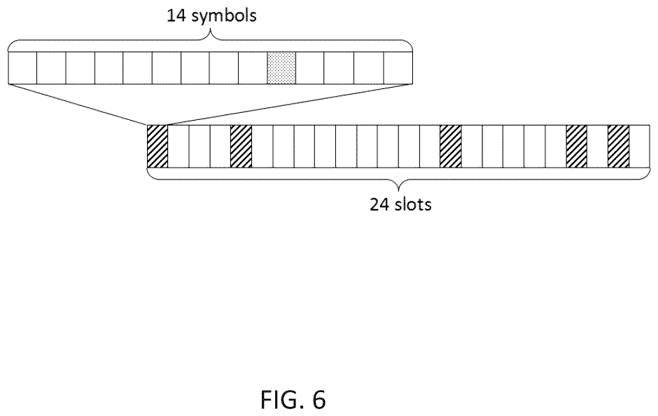

According to FIG. 6, the resource pattern is [0 2 7 10 11]*d, the unit position difference d=2 slots. This resource pattern is obtained via flipping [0 1 4 9 11]*d from right to left

As shown in FIG. 6, the sensing signal may configure to use the symbol 9 in each slot according to symbol offset=9 in the configuration information.

The proposed method in this embodiment is not limited to the time domain. In other words, this method may also apply to generate resource patterns in the frequency domain or other resource domains.

### Embodiment 7

This embodiment discloses, among other things, an example of a frequency-domain position-difference-based resource pattern.

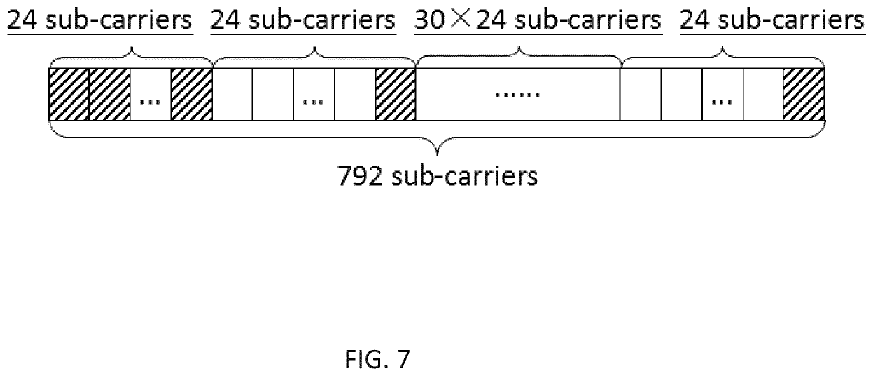

According to FIG. 7, a frequency-domain position-difference based resource pattern is generated with N₁=23, N₂=33 and d according to {1, 2, 3, . . . , N₁}∪{(N₁+1), 2(N₁+1), 3(N₁+1), . . . , N₂(N₁+1)}. Accordingly, the resource pattern can be expressed as {d, 2d, 3d, . . . , 23d}∪{24d, 48d, 72d, . . . , 792d}, and the unit position difference d=1 sub-carrier. The resource allocation includes starting sub-carrier=0, and time-domain resource allocations. Therefore, the signal uses the resources in the resource pattern starting from sub-carrier 0.

The proposed method in this embodiment is not limited to the frequency domain. In other words, this method may also apply to generate resource patterns in the time domain, or other resource domains.

### Embodiment 8

This embodiment discloses, among other things, an example of a frequency-domain position-difference-based resource pattern.

The resource pattern can be generated based on:

$$S = {⋃}_{i = 1}^{K} {S}_{i} , \\ where {S}_{i} = \{ \begin{matrix}\{ nd , n = 1 , 2 , … , {N}_{1} \} , i = 1. \\ \{ nd {\prod }_{j = 1}^{i - 1} ( {N}_{j} + 1 ) , n = 1 , 2 , … , {N}_{1} \} , i = 2 , … , K\end{matrix} .$$

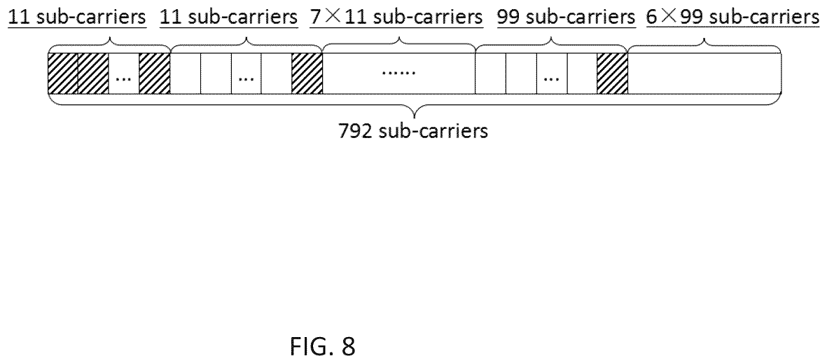

As shown in FIG. 8, the resource pattern can be expressed as {d, 2d, 3d, . . . , 11d}∪{22d, 44d, 66d, . . . , 99d}∪{198d, 297d, 396d, . . . , 792d}, and the unit position difference d=1 sub-carrier.

The proposed method in this embodiment is not limited to the frequency domain. In other words, this method may also apply to generate resource patterns in the frequency domain, or other resource domains.

### Embodiment 9

This embodiment discloses, among other things, an example of a frequency-domain position-difference-based resource pattern.

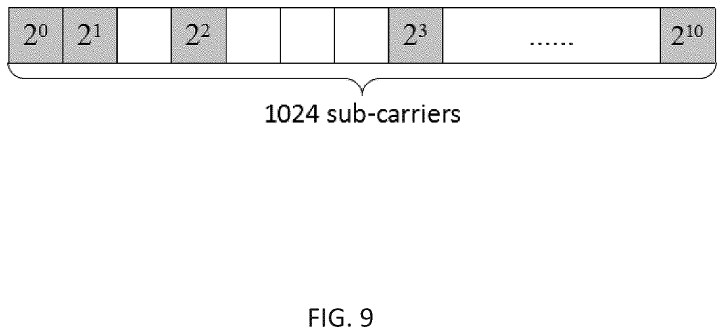

As shown in FIG. 9, the resource pattern can be expressed as [2⁰, 2¹, 2², . . . , 2¹⁰]*d, and the unit position difference d=1 sub-carrier. This resource pattern is generated via setting N=10 of {d, 2d, 4d, . . . , 2^{N}d}. The resource allocation includes starting sub-carrier =0, and time-domain resource allocations. Therefore, the signal uses the resources in the resource pattern starting from sub-carrier 0.

The proposed method in this embodiment is not limited to the frequency domain. In other words, this method may also apply to generate resource patterns in the time domain or other resource domains.

### Embodiment 10

This embodiment discloses, among other things, an example of a joint time-domain and a frequency domain position-difference-based resource pattern.

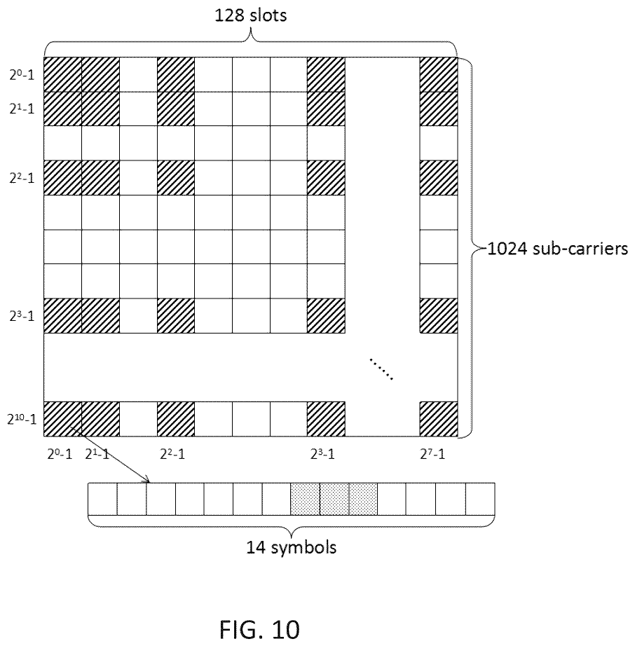

As shown in FIG. 10, the resource pattern can be expressed as [2⁰-1, 2¹-1, 2²-1, . . . , 2⁷-1]*d, and the unit position difference d=1 slot.

In the frequency domain, the resource pattern is [2⁰-1, 2¹-1, 2²-1, . . . , 2¹⁰-1]*d, and the unit position difference d=1 sub-carrier.

The configuration includes both resource pattern information and resource allocation information. The time domain starting position is decided by SFN0=9, slot offset=0 and symbol offset=7, 8, 9, and the frequency starting position is decided by starting sub-carrier=0.

According to the configuration, the allocated resources can be decided. In each selected slot, symbols 7, 8, and 9 are configured to be used.

The proposed method in this embodiment is not limited to the time domain. In other words, this method may also apply to generate resource patterns in the frequency domain or other resource domains.

### Embodiment 11

This embodiment discloses, among other things, examples involving

This embodiment shows a joint time-and frequency-domain position-difference-based resource pattern. In the time domain, the resource pattern is [0 1 2 5 10 15 26 37 48 59 70 81 87 93 99 100 101]*d, and the unit position difference d=1 slot. In each selected slot, the symbol 0 is used. In the frequency domain, the resource pattern is [2⁰-1, 2¹-1, 2²-1, . . . , 2¹⁰-1]*d, which is generated via shifting {d, 2d, 4d, . . . , 2^{N}d} with N=10 by −1, and the unit position difference d=1 sub-carrier. This embodiment shows the time and frequency domain resource pattern can be generated by different methods.

The configuration includes both resource pattern information and the resource allocation information. The time domain starting position are decided by SFN0=31, slot offset=0 and symbol offset=0, and the frequency starting position is decided by starting sub-carrier=0.

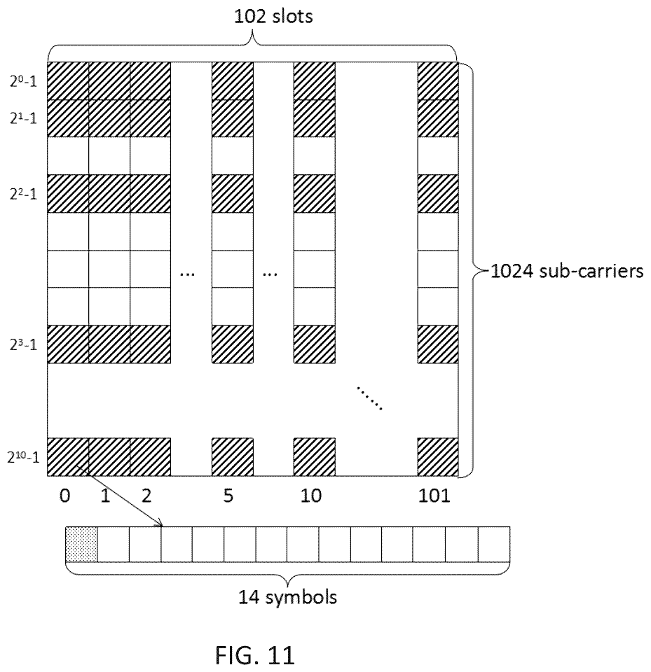

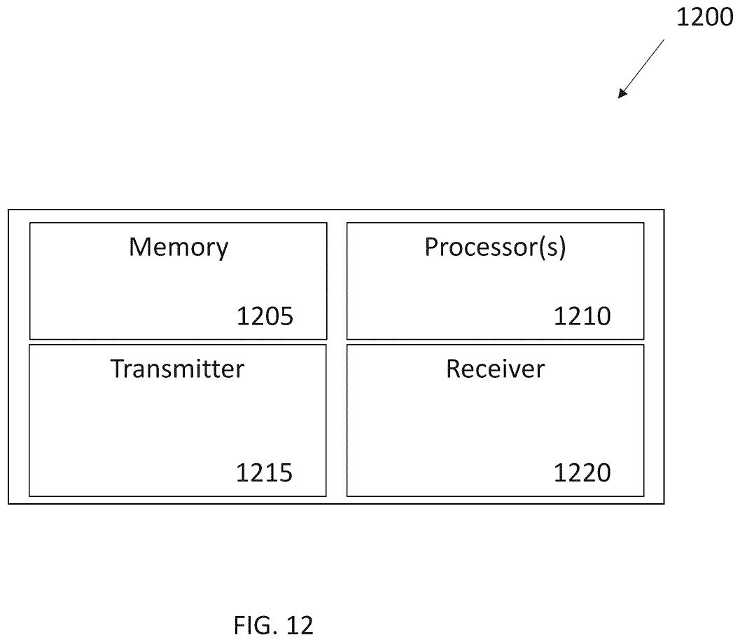

FIG. 12 shows an exemplary block diagram of a hardware platform 1200 that may be a part of a network device (e.g., base station) or a communication device (e.g., a user equipment (UE)). The hardware platform 1200 includes at least one processor 1210 and a memory 1205 having instructions stored thereupon. The instructions upon execution by the processor 1210 configure the hardware platform 1200 to perform the operations described in FIGS. 1 to 11 and in the various embodiments described in this patent document. The transmitter 1215 transmits or sends information or data to another device. For example, a network device transmitter can send a message to user equipment. The receiver 1220 receives information or data transmitted or sent by another device. For example, user equipment can receive a message from a network device.

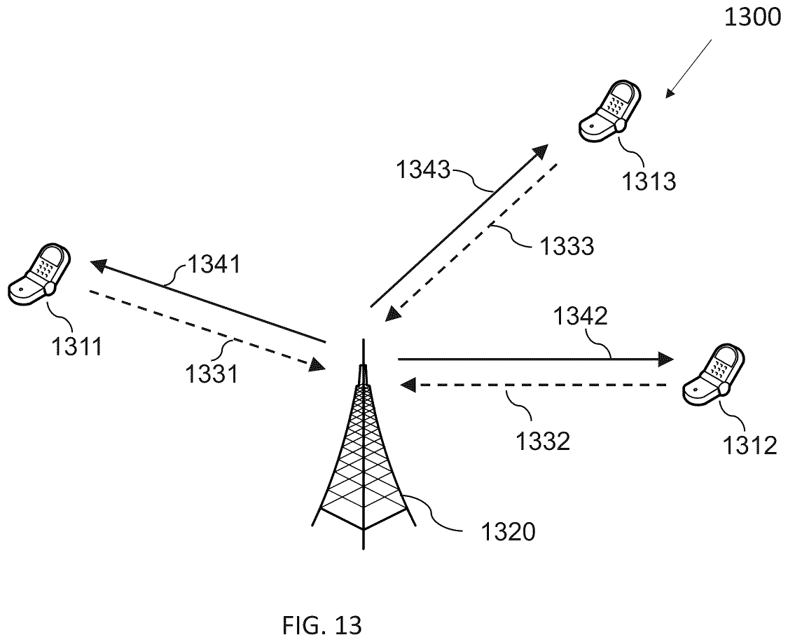

The implementations as discussed above will apply to a network communication. FIG. 13 shows an example of a communication system (e.g., a 6G or NR cellular network) that includes a base station 1320 and one or more user equipment (UE) 1311, 1312 and 1313. In some embodiments, the UEs access the BS (e.g., the network) using a communication link to the network (sometimes called uplink direction, as depicted by dashed arrows 1331, 1332, 1333), which then enables subsequent communication (e.g., shown in the direction from the network to the UEs, sometimes called downlink direction, shown by arrows 1341, 1342, 1343) from the BS to the UEs. In some embodiments, the BS send information to the UEs (sometimes called downlink direction, as depicted by arrows 1341, 1342, 1343), which then enables subsequent communication (e.g., shown in the direction from the UEs to the BS, sometimes called uplink direction, shown by dashed arrows 1331, 1332, 1333) from the UEs to the BS. The UE may be, for example, a smartphone, a tablet, a mobile computer, a machine to machine (M2M) device, an Internet of Things (IoT) device, and so on.

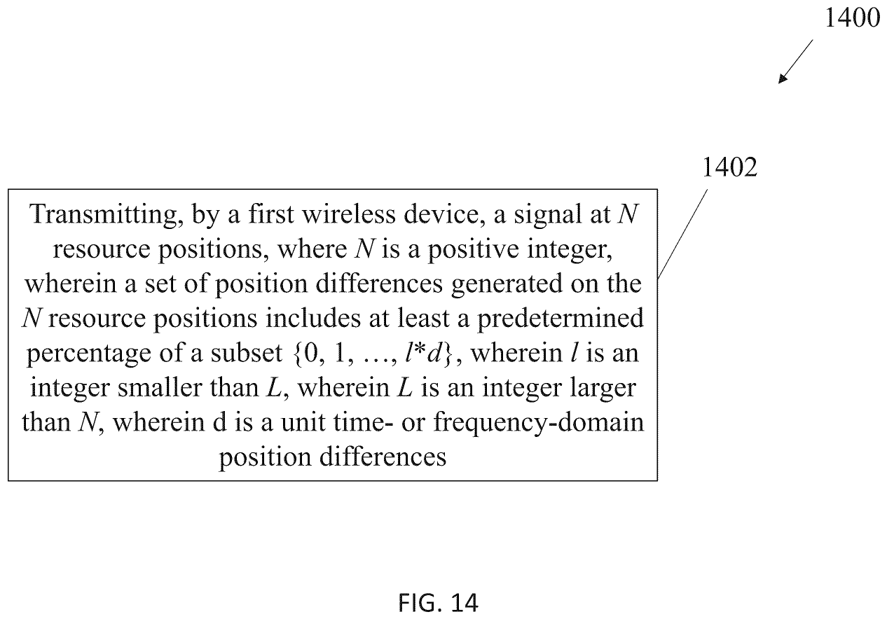

FIG. 14 shows an example flowchart representation of a method for wireless communication in accordance with one or more embodiments of the present technology. Operation 1402 includes transmitting, by a first wireless device, a signal at N resource positions, where N is a positive integer, wherein a set of position differences generated on the N resource positions includes at least a predetermined percentage of a set {0, d, 2d, . . . , (L−1)d}, wherein Lis an integer larger than N, wherein d is a unit time-or frequency-domain position differences.

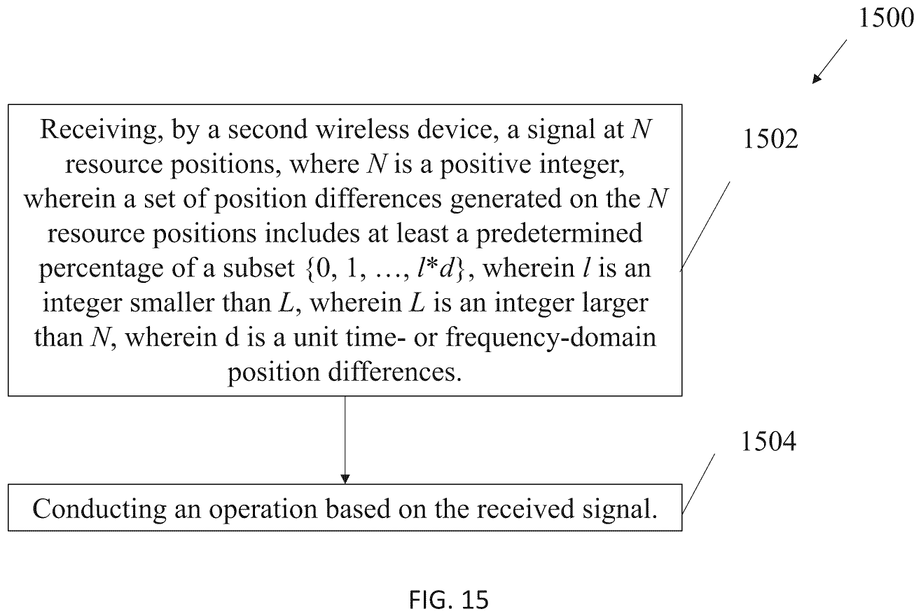

FIG. 15 show an example flowchart representation of a method for wireless communication in accordance with one or more embodiments of the present technology. Operation 1502 includes receiving, by a second wireless device, a signal at N resource positions, where N is a positive integer, wherein a set of position differences generated on the N resource positions includes at least a predetermined percentage of a set {0, d, 2d, . . . , (L−1)d}, wherein Lis an integer larger than N, wherein d is a unit time-or frequency-domain position differences. Operation 1504 includes conducting an operation based on the received signal.

Various preferred embodiments and additional features of the above-described method of FIGS. 14-15 are as follows. Further examples are described with reference to embodiments 1 to 11.

In one example aspect, a wireless communication method is disclosed. The method includes. transmitting, by a first wireless device, a signal at N resource positions, where N is a positive integer, wherein a set of position differences generated on the N resource positions includes at least a predetermined percentage of a set {0, d, 2d, . . . , (L−1)d}, wherein L is an integer larger than N, wherein dis a unit time-or frequency-domain position differences.

In another example aspect, another wireless communication method is disclosed. The method includes receiving, by a second wireless device, a signal at N resource positions, where N is a positive integer, wherein a set of position differences generated on the N resource positions includes at least a predetermined percentage of a set {0, d, 2d, . . . , (L−1)d}, wherein Lis an integer larger than N, wherein dis a unit time-or frequency-domain position differences; and conducting an operation based on the received signal.

In some embodiments, wherein the predetermined percentage is 100%.

In some embodiments, the above methods further comprise determining the resource positions of N resources according to a resource configuration information indicative of the N resource positions.

In some embodiments, the resource configuration information includes at least one of 1) resource pattern information, 2) positions of resource pattern elements, 3) a resource pattern index in a resource pattern list, 4) a parameter of a resource pattern generation method, 5) a unit position difference d, and 6) a time-domain starting positions, 7) a frequency-domain starting positions and 8) a time length, or 9) a bandwidth.

In some embodiments, the N resource positions are in time domain representing at least one of 1) multiple symbols, 2) slots, 3) frames, or 4) other time occasions.

In some embodiments, the N resource positions are in frequency domain representing at least one of 1) multiple sub-carriers, 2) frequencies, or 3) other frequency occasions.

In some embodiments, the set of position differences is {0, d, 2d, . . . , (L−1)d}.

In some embodiments, the N resource positions comprise positions generated

through shifting a resource pattern {d, 2d, 3d, . . . , N₁d}∪{(N₁+1)d, 2(N₁+1)d, 3(N₁+1)d, . . . , N₂(N₁+1)d} by a common offset; wherein N₁ and N₂ are positive integers.

In some embodiments, the N resource positions comprise positions by shifting a resource pattern

$$S = {⋃}_{i = 1}^{K} {S}_{i} , \\ where {S}_{i} = \{ \begin{matrix}\{ nd , n = 1 , 2 , … , {N}_{1} \} , i = 1. \\ \{ nd {\prod }_{j = 1}^{i - 1} ( {N}_{j} + 1 ) , n = 1 , 2 , … , {N}_{1} \} , i = 2 , … , K .\end{matrix} ,$$

by a common offset, wherein N₁ and K are positive integers

In some embodiments, the N resource positions comprise positions generated through positions shifting a resource pattern {d, 2d, 4d, . . . , 2^{N}d} by a common offset.

In some embodiments, the N resource positions comprise positions shifting a resource pattern in a table.

In some embodiments, the resource pattern can be replaced by a resource pattern shifting a constant value offset, and/or, flipping left to right of an original resource pattern.

In some embodiments, the table is:

| N | L | Resource Pattern |
|---|---|---|
| 3 | 4 | [0 1 3]*d; |
| 4 | 7 | [0 1 4 6]*d; |
| 5 | 10 | [0 1 2 6 9]*d; |
| | | [0 1 4 7 9]*d; |
| 6 | 14 | [0 1 2 6 10 13]*d; |
| | | [0 1 4 5 11 13]*d; |
| | | [0 1 6 9 11 13]*d; |
| 7 | 18 | [0 1 2 3 8 13 17]*d; |
| | | [0 1 2 6 10 14 17]*d; |
| | | [0 1 2 8 12 14 17]*d; |
| | | [0 1 2 8 12 15 17]*d; |
| | | [0 1 4 10 12 15 17]*d; |
| | | [0 1 8 11 13 15 17]*d; |
| 8 | 24 | [0 1 2 11 15 18 21 23]*d; |
| | | [0 1 4 10 16 18 21 23]*d; |
| 9 | 30 | [0 1 2 14 18 21 24 27 29]*d; |
| | | [0 1 4 10 16 22 24 27 29]*d; |
| | | [0 1 3 6 13 20 24 28 29]*d; |
| 10 | 37 | [0 1 3 6 13 20 27 31 35 36]*d; |
| 17 | 102 | [0 1 2 5 10 15 26 37 48 59 70 81 87 |
| | | 93 99 100 101]*d; |
| 18 | 113 | [0 1 2 5 10 15 26 37 48 59 70 81 92 |
| | | 98 104 110 111 112]*d; |

In some embodiments, the N resource positions are independently employed in time domain and frequency domain.

In some embodiments, the N resource positions are generated through shifting a constant value offset based on a flipping mapping in a resource set based on an existing resource pattern. In some embodiments, at least part of the signal is used as reference signal or

synchronization signal.

In some embodiments, the signal further comprises a sensing resource configuration is sent to other wireless nodes.

In some embodiments, a sensing resource configuration information is transmitted before transmitting the signal.

It will be appreciated that the present document discloses methods and apparatus related to configuration design from different aspects in position difference-based time-frequency resource patterns for wireless sensing signals using in ISAC or other wireless communication systems. One challenge of ISAC is allocating a limited spectrum of resources to ensure the performance of both sensing and communication functions. This patent application discloses multiple methods and apparatus schemes for the design of non-uniform resource patterns. The proposed methods and schemes in the current application are beneficial in increasing the flexibility and efficiency of communication resource utilization in ISAC or other communication systems.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
transmitting, by a wireless device, a signal at N resource positions, where Nis a positive integer, wherein a set of position differences generated on the N resource positions includes at least a predetermined percentage of a set {0, d, 2d, . . . , (L−1)d}, wherein L is an integer larger than N, wherein dis a unit time-or frequency-domain position differences.

2. The method of claim 1, wherein the predetermined percentage is 100%.

3. The method of claim 1, further comprising determining the N resource positions of N resources according to a resource configuration information indicative of the N resource positions.

4. The method of claim 3, wherein the resource configuration information includes at least one of 1) resource pattern information, 2) positions of resource pattern elements, 3) a resource pattern index in a resource pattern list, 4) a parameter of a resource pattern generation method, 5) a unit position difference d, and 6) a time-domain starting positions, 7) a frequency-domain starting positions and 8) a time length, or 9) a bandwidth.

5. The method of claim 1, wherein the N resource positions are in (a) a time domain representing at least one of 1) multiple symbols, 2) slots, 3) frames, or 4) other time occasions, or (b) a frequency domain representing at least one of 1) multiple sub-carriers, 2) frequencies, or 3) other frequency occasions.

6. The method of claim 1, wherein the set of position differences is {0, d, 2d, . . . , (L−1)d}.

7. The method of claim 1, wherein the N resource positions comprise:
(a) positions generated through shifting a first resource pattern, {d, 2d, 3d, . . . , N₁d}∪{(N₁+1)d, 2(N₁+1)d, 3(N₁+1)d, . . . , N₂(N₁+1)d}, by a first common offset, wherein N₁ and N₂ are positive integers; or
(b) positions generated by shifting a second resource pattern,
$$S = {⋃}_{i = 1}^{K} {S}_{i} , \\ where {S}_{i} = \{ \begin{matrix}\{ nd , n = 1 , 2 , … , {N}_{1} \} , i = 1. \\ \{ nd {\prod }_{j = 1}^{i - 1} ( {N}_{j} + 1 ) , n = 1 , 2 , … , {N}_{1} \} , i = 2 , … , K .\end{matrix} ,$$
by a second common offset, wherein K is a positive integer; or
(c) positions generated by shifting a third resource pattern, {d, 2d, 4d, . . . , 2^{N}d}, by a third common offset; or
(d) positions generated by shifting a fourth resource pattern in a table.

8. The method of claim 7, wherein the first resource pattern, the second resource pattern, the third resource pattern, or the fourth resource pattern can be replaced by a pattern shifting a constant value offset, and/or, flipping an original resource pattern from left to right.

9. The method of claim 7, wherein the table is:

| N | L | Resource Pattern |
|---|---|---|
| 3 | 4 | [0 1 3]*d; |
| 4 | 7 | [0 1 4 6]*d; |
| 5 | 10 | [0 1 2 6 9]*d; |
| | | [0 1 4 7 9]*d; |
| 6 | 14 | [0 1 2 6 10 13]*d; |
| | | [0 1 4 5 11 13]*d; |
| | | [0 1 6 9 11 13]*d; |
| 7 | 18 | [0 1 2 3 8 13 17]*d; |
| | | [0 1 2 6 10 14 17]*d; |
| | | [0 1 2 8 12 14 17]*d; |
| | | [0 1 2 8 12 15 17]*d; |
| | | [0 1 4 10 12 15 17]*d; |
| | | [0 1 8 11 13 15 17]*d; |
| 8 | 24 | [0 1 2 11 15 18 21 23]*d; |
| | | [0 1 4 10 16 18 21 23]*d; |
| 9 | 30 | [0 1 2 14 18 21 24 27 29]*d; |
| | | [0 1 4 10 16 22 24 27 29]*d; |
| | | [0 1 3 6 13 20 24 28 29]*d; |
| 10 | 37 | [0 1 3 6 13 20 27 31 35 36]*d; |
| 17 | 102 | [0 1 2 5 10 15 26 37 48 59 70 81 87 93 99 100 101]*d; |
| 18 | 113 | [0 1 2 5 10 15 26 37 48 59 70 81 92 98 104 110 111 112]*d; |

10. The method of claim 1, wherein the N resource positions are (a) independently employed in a time domain and a frequency domain or (b) generated through shifting a constant value offset based on a flipping mapping in a resource set based on an existing resource pattern.

11. The method of claim 1, wherein at least part of the signal is used as reference signal or synchronization signal.

12. The method of claim 1, wherein the signal further comprises a sensing resource configuration is sent to other wireless nodes.

13. The method of claim 1, wherein a sensing resource configuration information is transmitted before transmitting the signal.

14. A method for wireless communication, comprising:
receiving, by a wireless device, a signal at N resource positions, where N is a positive integer, wherein a set of position differences generated on the N resource positions includes at least a predetermined percentage of a set {0, d, 2d, . . . , (L−1)d}, wherein L is an integer larger than N, wherein d is a unit time-or frequency-domain position differences; and
conducting an operation based on the signal.

15. An apparatus for wireless communication, implemented at a wireless device, the apparatus comprising:
one or more processors configured to:
transmit a signal at N resource positions, where N is a positive integer, wherein a set of position differences generated on the N resource positions includes at least a predetermined percentage of a set {0, d, 2d, . . . , (L−1)d}, wherein L is an integer larger than N, wherein d is a unit time-or frequency-domain position differences.

16. The apparatus of claim 15, wherein the predetermined percentage is 100%.

17. The apparatus of claim 15, wherein the one or more processors are further configured to:
determine N resource positions of N resources according to a resource configuration information indicative of the N resource positions.

18. The apparatus of claim 15, wherein the N resource positions comprise:
(a) positions generated through shifting a first resource pattern, {d, 2d, 3d, . . . , N₁d}∪{(N₁+1)d, 2(N₁+1)d, 3(N₁+1)d, . . . , N₂(N₁+1)d}, by a first common offset, wherein N₁ and N₂ are positive integers; or
(b) positions generated by shifting a second resource pattern,
$$S = {⋃}_{i = 1}^{K} {S}_{i} , \\ where {S}_{i} = \{ \begin{matrix}\{ nd , n = 1 , 2 , … , {N}_{1} \} , i = 1. \\ \{ nd {\prod }_{j = 1}^{i - 1} ( {N}_{j} + 1 ) , n = 1 , 2 , … , {N}_{1} \} , i = 2 , … , K\end{matrix} .$$
by a second common offset, wherein K is a positive integer; or
(c) positions generated by shifting a third resource pattern, {d, 2d, 4d, . . . , 2^{N}d}, by a third common offset; or
(d) positions generated by shifting a fourth resource pattern in a table.

19. The apparatus of claim 18, wherein the table is:

| N | L | Resource Pattern |
|---|---|---|
| 3 | 4 | [0 1 3]*d; |
| 4 | 7 | [0 1 4 6]*d; |
| 5 | 10 | [0 1 2 6 9]*d; |
| | | [0 1 4 7 9]*d; |
| 6 | 14 | [0 1 2 6 10 13]*d; |
| | | [0 1 4 5 11 13]*d; |
| | | [0 1 6 9 11 13]*d; |
| 7 | 18 | [0 1 2 3 8 13 17]*d; |
| | | [0 1 2 6 10 14 17]*d; |
| | | [0 1 2 8 12 14 17]*d; |
| | | [0 1 2 8 12 15 17]*d, |
| | | [0 1 4 10 12 15 17]*d; |
| | | [0 1 8 11 13 15 17]*d; |
| 8 | 24 | [0 1 2 11 15 18 21 23]*d; |
| | | [0 1 4 10 16 18 21 23]*d; |
| 9 | 30 | [0 1 2 14 18 21 24 27 29]*d; |
| | | [0 1 4 10 16 22 24 27 29]*d; |
| | | [0 1 3 6 13 20 24 28 29]*d; |
| 10 | 37 | [0 1 3 6 13 20 27 31 35 36]*d; |
| 17 | 102 | [0 1 2 5 10 15 26 37 48 59 70 81 87 93 99 100 101]*d; |
| 18 | 113 | [0 1 2 5 10 15 26 37 48 59 70 81 92 98 104 110 111 112]*d; |

20. An apparatus for wireless communication, implemented at a wireless device, the apparatus comprising:
one or more processors configured to:
receive a signal at N resource positions, where N is a positive integer, wherein a set of position differences generated on the N resource positions includes at least a predetermined percentage of a set {0, d, 2d, . . . , (L−1)d}, wherein L is an integer larger than N, wherein d is a unit time-or frequency-domain position differences; and
conduct an operation based on the signal.
